(19) United States
(12) Patent Application Publication
(10) Pub. No.: US 2006/0098093 A1
(43) Pub. Date: May 11, 2006

(54) Stereo night vision system for vehicles

(76) Inventors: Stefan Hahn, Ulm (DE); Markus Kreuzer, Hochdorf (DE); Bernhard Straub, Starzach (DE)

Correspondence Address: AKERMAN SENTERFITT, 222 LAKEVIEW AVENUE, SUITE 400, P.O. BOX 3188, WEST PALM BEACH, FL, 33401, US

(21) Appl. No.: 10/527,722

(22) PCT Filed: Sep. 8, 2003
(86) PCT No.: PCT/EP03/09929

§ 371 Date: Sep. 26, 2005

(30) Foreign Application Priority Data
Sep. 12, 2002 (DE) 102 42 262.1

(51) Int. Cl. H04N 7/18; H04N 13/04; H04N 5/33; B60Q 1/00; G08G 1/14

(52) U.S. Cl. 348/148; 348/51; 348/164; 340/435; 340/932.2

(57) ABSTRACT

The invention relates to a night vision system for vehicles. According to the invention, the road in front of the vehicle is stereoscopically recorded via two night vision-capable cameras, e.g. infrared or low-light-level cameras that are mounted in the front of the vehicle at a distance from one another. Corresponding stereoscopic image display devices permit the driver to observe the road in front of the vehicle in three-dimensions. Objects located in front of the vehicle can be detected in critical areas by means of additional image evaluating devices and can be differently accentuated or marked in the image representation. The night vision system can be designed to also permit a two-dimensional display of images or data alternatively or in conjunction with 3D representation. In an enhanced embodiment, head movements and/or the line of sight of the driver are/is detected and used for a corresponding tracking of the image display.

### BACKGROUND OF THE INVENTION

1. Field of the Invention

The invention relates to night vision systems in which images are recorded by cameras and subsequently conditioned electronically. The invention relates in particular to such systems that are suitable for use in vehicles on the basis of their properties.

2. Related Art of the Invention

The fact that the accident rate is substantially higher at night than during the day is substantiated by accident statistics. The reason is that the auto driver primarily makes use of the sense of sight in order to control a vehicle and estimate danger. At night, there is much less information about the surroundings that can be gathered by sight; in particular unexpected laterally occurring dangers are perceived later.

However, the speeds being driven and reaction times they require remain essentially the same.

There is a range of technical systems in vehicles that support the driver in perceiving the driving path lying ahead at night. These consist generally of a night vision capable camera (with additional illumination device if appropriate) and reproduction of the recorded scene for the driver. Thus, for example, use has been made of thermal imaging cameras (BMW) or it has been proposed to use UV illuminating devices in conjunction with fluorescing marking elements (Volvo).

A stereoscopic arrangement of infrared cameras has been described in IEEE Intelligent Vehicles Symposium (Proceedings IV-2001, May 13-17, 2001 Tokyo Japan). In this system, the area of approximately 30 to 80 meters lying in the driving direction is sensed simultaneously by 2 infrared cameras that are fitted in the front region of the vehicle and are at a spacing of 360 mm from one another. Objects in the driving direction (for example passers-by) are detected by comparing the stereoscopic images, as is their distance from the vehicle.

The video image picked up by cameras is conditioned and reproduced in various ways for the driver in the known systems. Customary, for example, are monitors in the dashboard area or head-up displays that are fitted in the driver's visual range. Reflection into the bottom of the windshield can also be performed as an alternative.

With head-up displays in which the driver looks through in the driving direction, it is a problem to bring the camera image precisely into congruence with the scene directly perceived. Again, it is difficult to ensure a display of the camera image that does not in some circumstances cover up details of the real scene situated there behind, owing to excessively high levels of intensity. When monitors are arranged separately, for example in the console or in the region of the bottom of the windshield, in order to pick up the information displayed the driver must in each case look away from the driving direction—in a way rather similar to looking away when using an interior or exterior mirror.

The known systems therefore have the disadvantage that the driver's attentiveness can be diverted. So that a night vision system increases safety and does not additionally divert the driver, the latter must grasp and interpret the reproduced scene in a particularly simple and intuitive way.

### SUMMARY OF THE INVENTION

Starting from this prior art, it is the object of the present invention to develop an improved system that largely overcomes the said disadvantages and has additional advantages.

This object is achieved in the case of a night vision system having the features of the preamble of claim 1 by means of the characterizing features of claim 1. Further details of the invention and advantages of various embodiments follow from the features of the subclaims.

The inventive system and corresponding apparatuses are described below with the aid of preferred embodiments.

The present invention serves the purpose of presenting the driver with an image of the scene in front in a way that can be grasped as quickly as possible in conjunction with minimal diversion. Use is made for this purpose of the fact that a person can perceive a depth, offset of the scene, given with stereoscopically presented images. In the case of the system according to the invention, two conventional night vision capable cameras (e.g. infrared or residual light cameras) are used in a stereo arrangement for image pickup and the resulting scene is displayed to the driver by means of stereoscopic reproduction devices. If the base width of the cameras is selected to be greater than the human eye base, the stereo effect is amplified and the depth offset can be detected even more effectively by the driver. Thus, when three times the eye base is selected it is still possible to perceive a depth offset of up to approximately 70 m. Owing to the three-dimensional reproduction, the driver can grasp the geometrical arrangement of objects in the driving direction intuitively, and therefore quickly and with minimal diversion.

Various devices can be used for reproducing the stereo images. Thus, in a first embodiment the stereo images can be displayed on a conventional monitor or LCD display. Alternatively, reflection onto the windshield is also possible. In this case, the position is preferably selected such that in the event of looking in the driving direction the reproduction is superimposed on the real field of view. Other positions (consol, dashboard region, bottom of the windshield) are likewise possible, but require a change of direction of view during driving.

The stereo images can, for example, be split up via optical aids that are assigned directly to the viewer. Customary here are, for example, special spectacles that function according to the anaglyph method (color), the method of temporal stereography (shutter) or the principle of polarization stereography (polarization filter). Combinations of such methods are also possible. Since these methods are based on the exclusion principle (it is only the respectively assigned images or image components that can be viewed separately for each eye), they reduce the quantity of light and therefore impede the direct view to the outside in some circumstances.

Other methods that proceed according to the autostereoscopic principle achieve a three-dimensional perception without the need for the viewer to wear optical aids (free viewing). A split up of the stereo images can be based in this case on diffraction-based elements, for example diffractive optical elements (DOEs, gratings) or holographic elements (HOE) that emit the stereoscopic information, shown on a display or displayed by projection, in various directions. The image can also be split up via refraction-based elements, for example arrays of longitudinal prisms, microlens systems, cylindrical lens arrays or field lenses that reflect the various stereoscopic image components differently in cooperation with the driving of the display or projector. Also suitable are reflecting elements that direct stereoscopic information to the viewer in a directionally selective fashion.

In another embodiment, the propagation of light is prevented in specific directions via barrier grids or color masks for the purpose of splitting up the stereo images spatially (exclusion method or covering method).

As an alternative, the stereo images can be split up via structured illumination (parallax illumination) of displays (e.g. LED displays), different information being emitted in different directions by a single structural unit of the overall illumination.

Instead of a simultaneous spatial separation of the two stereo image components, the stereo images can also be split up by means of time-division multiplexing (moving-slit method) in the case of which the stereo information is split up sequentially so quickly in the time domain into the respective directions of view for various image contents that the viewer gains the impression of a complete stereo image.

An impression of depth and effect of depth can also be achieved by means of a 2% D display, in which two or more image planes are arranged one behind another. In this case, the image information is displayed by reflecting partial images into the individual image planes arranged one behind the other, for example via semitransparent mirrors, it being possible to back up the image display by suitable weighting of contrast and intensity.

Another modern principle for three-dimensional image reproduction is likewise suitable for use in the proposed night vision system. This principle is based on the electroholographic method in which a reduced hologram function is compiled from the stereographic information and is displayed by means of scanning laser systems and electrooptic modulators (principle of MIT, Massachusetts Institute of Technology).

Further methods are known for 3D image reproduction, and are suitable for the night vision system according to the invention. Thus, the stereoscopic information can be transferred onto volumetric displays (for example periodically moving displays, specially shaped, rotating or moving projection screens, nonlinear effects in volumetric media such as, for example, 2-photon fluorescence excited by space-division multiplexed laser beams). Again, the stereo images can be split up via two or more projectors whose emitted images are perceived in an angularly selective fashion as real or virtual images (for example stereoscopic head-up displays with two projectors).

Combinations of the various methods set forth here can also be used for the night vision system according to the invention.

In an extended embodiment, means are provided for detecting the driver's head and/or eye position (observation of the driver's direction of view). It is possible for this purpose to use, for example, one or more cameras in the interior of the vehicle with image evaluation appropriately connected downstream but the eye position can also be determined (for example by triangulation) with the aid of infrared or ultrasonic probes. The data thus obtained on the current direction of view can be used to drive the above-named devices for the three-dimensional image reproduction in such a way that the stereo images are tracked as a function of the head or pupil position (for example by the displacement of masks, light sources or the light modulator) so that the stereoscopic impression is maintained even when the head position is varied. It is possible in this case to interpolate various directions of view and to feed the stereo images to the viewer in a new direction of view given a changed head/eye position, thus producing a movement parallax.

If the image reproduction device is designed such that there is no tracking as a function of the eye position, the image can be split up spatially in such a way that the stereo impression arises for a prescribed (for example central) head position, and that upon a displacement of the head from the defined position both eyes receive identical images and so only a purely two dimensional display takes place.

In a particular embodiment, the different 3D images are selectively projected via appropriate light sources onto the respective retina of the viewer. It is possible for this purpose to make use, for example, of laser systems or special LED projectors.

In the case of all the three-dimensional image reproduction devices set forth, the objects detected by the camera system in critical distance ranges of the driving path lying ahead can additionally be optically marked by electronic conditioning in order to support the driver (for example by coloring, contrasting, flashing, etc.). It is also possible for such objects to be selectively displaced into other spatial planes of the 3D reproduction, in order in this way to effect a heightened attentiveness of the driver (quicker detection of critical situations).

A further advantage of the night vision system according to the invention consists in the possibility of being able to alternate optionally between two-dimensional and three-dimensional display, or to combine the two forms of display with one another. Numerous variations are possible in this case, for example the stereoscopic display can be deactivated in order to reproduce two-dimensional information at a higher resolution.

Again, a normal mode of the night vision system could be configured such that information (for example driving parameters of speed, rotational speed, navigation data, etc) is reproduced as a 2D display, and situations of the driving path lying ahead are reproduced as a 3D display.

The night vision system according to the invention offers the fundamental advantage that the driving path lying ahead is perceived by means of the three-dimensional display in an accustomed way, that is to say as under good seeing conditions by day. This reduces the fatigue phenomena which otherwise tend to occur when driving at night. In addition, the new system permits the accustomed intuitive reaction (developed from driving experience) to potential danger points with an appropriately shortened reaction time, which contributes to driving safety.

Additional information permitting an early reaction to critical driving situations can be supplied to the driver by the night vision system according to the invention through the use of extended warning indications (markings or accentuations of objects relevant to safety, displacement into other spatial planes, 2D-3D combinations, etc.).

1. A night vision system for vehicles, having at least two night vision capable cameras that are fitted on the vehicle at a spacing from one another in such a way that a stereoscopic recording is made of the driving path situated in front of the vehicle, and having means which condition the image signals of the night vision capable cameras and reproduce them optically for the driver, wherein means are present that generate for the driver a stereoscopic reproduction of the image signals.

2. The night vision system as claimed in claim 1, wherein the means for generating a stereoscopic reproduction project image components from various night vision capable cameras in different spatial directions.

3. The night vision system as claimed in claim 1, wherein the means for generating a stereoscopic reproduction has elements that project image components in different spatial directions by means of optical diffraction (for example diffractive optical elements, gratings, holographic elements).

4. The night vision system as claimed in claim 1, wherein the means for generating a stereoscopic reproduction have elements that project image components in different spatial directions by means of optical refraction (for example arrays of longitudinal prisms, microlens arrangements, cylindrical lens arrays or field lenses).

5. The night vision system as claimed in claim 1, wherein the means for generating a stereoscopic reproduction have elements that project image components in different spatial directions by means of reflection (for example retroreflectors, partially reflecting elements).

6. The night vision system as claimed in claim 1, wherein the means for generating a stereoscopic reproduction have elements that separate image components optically by means of exclusion (for example barrier grid, color mask) or covering (for example polarization filter).

7. The night vision system as claimed in claim 1, wherein the means for generating a stereoscopic reproduction have elements that separate image components optically as a function of time.

8. The night vision system as claimed in claim 1, wherein the means for generating a stereoscopic reproduction have elements that illuminate image reproduction displays (for example LCD displays) in a structured fashion (parallax illumination).

9. The night vision system as claimed in claim 1, wherein the means for generating a stereoscopic reproduction have scanning laser systems and electrooptic modulators.

10. The night vision system as claimed in claim 1, wherein the means for generating a stereoscopic reproduction have at least two projectors that emit image components in an angularly selective fashion.

11. The night vision system as claimed in claim 1, wherein the means for generating a stereoscopic reproduction have elements (for example lasers, edge-emitting LEDs) that project image components directly onto the driver's retina.

12. The night vision system as claimed in claim 1, wherein means are present which detect the head and/or eye position or direction of view of the driver and drive the means for generating a stereoscopic reproduction as a function of the detected head and/or eye position or direction of view.

13. The night vision system as claimed in claim 12, wherein the head and/or eye position or direction of view of the driver is detected via cameras, ultrasound or infrared detectors fitted in the interior of the vehicle.

14. The night vision system as claimed in claim 12, wherein the means for generating a stereoscopic reproduction are driven in such a way that a movement parallax results.

15. The night vision system as claimed in claim 1, wherein the means for generating a stereoscopic reproduction have elements that are worn by the driver (for example polarization or color filter spectacles, mini displays, etc.).

16. The night vision system as claimed in claim 1, wherein the means for generating a stereoscopic reproduction have swinging or rotating displays.

17. The night vision system as claimed in claim 1, wherein the means for generating a stereoscopic reproduction have volumetric displays in which individual spatial points are excited to emit light by means of laser radiation, for example.

18. The night vision system as claimed in claim 1, wherein the conditioning of the image signals of the night vision capable cameras includes the detection and optical accentuation of objects in the driving direction.

19. The night vision system as claimed in claim 18, wherein the optical accentuation of the objects is performed by marking (for example coloring, contrasting, flashing).

20. The night vision system as claimed in claim 18, wherein the optical accentuation of the objects is performed by varying the apparent position (for example distance) in the stereoscopic reproduction.

21. The night vision system as claimed in claim 1, wherein in addition to the three-dimensional reproduction image components are also reproduced in a two-dimensional display.

22. The night vision system as claimed in claim 21, wherein the driving control parameters (speed, rotational speed etc) and/or navigation information (for example GPS) are reproduced as image components in a two-dimensional display.
